(19) United States
(12) Patent Application Publication
(10) Pub. No.: US 2022/0054911 A1
(43) Pub. Date: Feb. 24, 2022

(54) Protective Covers for Sports Equipment Handles

(71) Applicant: Lawrence Schweikert, Ellwood City, PA (US)

(72) Inventor: Lawrence Schweikert, Ellwood City, PA (US)

(21) Appl. No.: 17/089,991

(22) Filed: Nov. 5, 2020

Related U.S. Application Data
(60) Provisional application No. 63/067,442, filed on Aug. 19, 2020.

(51) Int. Cl. A63B 60/58; A63B 60/60

(52) U.S. Cl. CPC A63B 60/58; A63B 2102/182; A63B 60/60

(57) ABSTRACT

This present invention relates to a protective cover for use with a handle on a piece of sports equipment, such as a baseball bat, to protect the handle from the elements (e.g., rain, sleet, snow) and/or physical damage. The protective cover preferably includes a contoured interior with an integrated memory foam that provides a convenient location to place a pair of cleats or other accessory, a hook and loop fastener positioned on the exterior surface to attach additional accessories, and a patch or other surface upon which useful information may be recorded and displayed.

### CROSS-REFERENCE TO RELATED APPLICATION

The present application claims priority to, and the benefit of, U.S. Provisional Application No. 63/067,442, which was filed on Aug. 19, 2020 and is incorporated herein by reference in its entirety.

### FIELD OF THE INVENTION

The present invention relates generally to the field of covers for sport equipment having handles or grips, such as those used in baseball, softball, cricket, lacrosse, hockey, tennis, Jai alai, etc. The sports handle or grip cover protects the handle or grip from weather damage, and keeps the handle or grip covered when not in use to prevent damage to the same from rain, mud, dust, and UV damage and fading caused by the sun. The handle or grip cover is comprised of a cover contoured to the exact features of the handle or grip area to be covered, and may include a memory foam at the top of the handle or grip area cover. The cover may further comprise an accessory attachment that enables a user to place spikes, shoes, other footwear, gloves, head bands and the like on the sports equipment. The accessory attachment uses a hook and loop fastener strap to hang or receive gloves, head bands, wrist bands or the like, and a patch sewn onto the exterior surface thereby allowing the user to write his or her name or number to personalize and distinguish the cover from other items that may be stacked nearby. The sports equipment handle or grip cover is easily mounted and removed from the sports equipment, and does not rotate or twist around the handle, nor slip or slide off the handle once installed. Accordingly, the present disclosure makes specific reference thereto. Nonetheless, it is to be appreciated that aspects of the present invention are also equally useable with other like applications, devices and methods of manufacture.

### BACKGROUND

There are many types of sporting equipment that require a racquet, bat, stick or some other element in order to strike or hit a ball, birdie, puck, or other object as part of the game. One such example is a baseball or softball bat which is used to strike a baseball or softball as it travels across a plate. The barrel or trunk is the thicker portion of the bat, and is used to strike the ball. The handle is comparatively thin, so that a user can comfortably grip the bat in one's hands. Bats used for baseball, softball, and the like are generally constructed from a metal, such as aluminum, composite metal or wood. The handle of the bat generally has a temporarily affixed padded material for a secure and comfortable grip for the user. These types of coverings are purposely made and installed for a better grip during play, and to eliminate slipping. Further, such covers are relatively thin so that they do not add to the diameter of the handle. Accordingly, they do not protect the bat handle from sunlight, heat, moisture, rain, mud, dust and the like, and the bat handle can be damaged by repeated exposure to such elements over prolonged periods of time.

Sporting equipment such as bats, sticks, racquets and the like are also very important for both amateur and professional players, and a lot of care is required to prolong the life of the equipment. Such sporting equipment is oftentimes carried around in a backpack, and the structure and design of most backpacks are such that the handle or grip area of a the equipment is exposed to the elements. Prolonged exposure to sunlight, heat, moisture, rain, mud, dust and general inclement weather may result in damage to the handle. The life-span of such sporting equipment may also be reduced by careless handling of the same. For example, many times a user will carelessly drop a backpack or sports equipment carrying bag on the ground, in the back of a car, or on any other hard surface. This type of mishandling could cause damage to the uncovered and exposed handles. Additionally, backpacks carrying multiple pieces of sporting equipment may result in banging of the equipment together, thereby causing damage to the uncovered and exposed areas of the handles.

Therefore, there exists a long felt need for a protective cover for a handle or grip area that is designed to protect the handle from the elements and other damage when not in use. There is also a long felt need for a protective handle cover that enables a user to place shoes, sneakers, masks, helmets, etc. on the top of the handle without damaging the same, and to attach other accessories, such as gloves and the like, to the covered handle to ease the burden of having to simultaneously carry multiple items. Moreover, there is a long felt need in the art for a handle protective cover that remains securely but removably attached to the handle, and that offers a means to identify the protective cover and the equipment on which the cover is installed. Finally, there is a long felt need in the art for a protective cover that is customizable to suit the needs and preferences of the user, is relatively inexpensive to manufacture, and that is safe and easy to use.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a covering to protect the handle or grip area of a baseball, softball or cricket bat, a lacrosse or hockey stick, or a tennis or Jai alai racquet, etc. from exposure to the elements and other forms of physical damage. The protective cover preferably comprises a substantially tubular or cylindrical body having an interior surface, and an exterior surface, a closed top portion, an open bottom portion, and a cavity extending along a substantial length of the tubular body to receive the sporting equipment handle. The interior surface of the protective cover is form fitting and in contact with a substantial portion of the covered portion of the handle when installed thereon. The cover does not slip once installed on the handle of the equipment. More specifically, the cover may have ridges or other rubberized strips on the interior surface to prevent slipping of the cover from the handle. The ridges can run parallel to the length of the cover, may be perpendicular to the length of the cover or any other orientation that achieves the stated objectives.

The exterior surface of the protective cover has a patch sewn thereon to enable a user to write his or her personal contact information thereon, or the patch or other areas of the cover may be adorned with logos, trademarks or other indica of sports teams, colleges, marketing information and the like. More specifically, the patch is provided with a writable surface such that the information may be erased and rewritten any number of times. Additionally, the closed top portion of the protective cover has a memory foam (internally, externally or both) which becomes contoured to the exact features of the handle to be covered. Shoes, spikes, helmets and the like can also be placed on top of the protective cover once in place on the handle. An accessory holder is provided on the body of the protective cover and includes a hook and loop fastener strap around the exterior surface to hang or receive batting gloves, face shields, etc.

In a further embodiment of the present invention, a protective cover for a sporting equipment handle is disclosed, and comprises a generally tubular or other shaped body comprised of an at least partially elastic and/or stretchable material The protective cover has an open end to facilitate the entry of the handle into the enclosed cavity present within the shaped body, and a top closed end having a memory foam to contour to the shape of the sporting equipment being protected. The top end covers the top of the handle and the tubular body is of a suitable length to cover the remaining portion of the handle. The top end of the protective cover has a width that is able to cover the enlarged head of the handle, such as for a baseball bat, and the bottom portion of the cover is elastic such that the size at the end of the handle which is near to the barrel is properly covered and can expand slightly to cover over any bends or enlarged areas of the sporting equipment. A patch or other surface that is capable of being written on may be sewn or otherwise attached to a portion of the protective cover so that the user may provide his or her contact or other useful information thereon.

In yet another embodiment of the present invention, a method for protecting a handle of sporting equipment from weather and other physical damage when not in use is disclosed. The method comprises the step of initially providing a handle with a protective cover made up of elastic and/or a stretchable material. The protective cover includes a shaped body, an open bottom end, a closed top end, a memory foam at the closed top end, a hook and loop fastener on an exterior surface of the shaped body, and a patch present on the exterior surface to write the desired information by the user. Next, the open bottom end of the shaped body is slid over the handle until the top closed end abuts the top of the handle. Cleats, shoes, helmets or the like can then be placed on the top of the cover, when in position over the handle. The shape of the handle end can be contoured through the use of memory foam, and finally attaching batting gloves or other sporting accessories to the protective cover via the hook and loop fastener provided on the exterior of the cover.

In its various embodiments, the protective cover of the present invention may have multiple layers of the same or different material to provide adequate protection from such things as rain, mud, dust, ultraviolet rays from the sun, and other physical damage. Once properly installed, the protective cover does not slip off of the handle, and generally conforms to the shape of the handle. The patch on the exterior surface of the protective cover facilitates the prominent display of a team name, company name, player name, or other information, especially in instances when the protective cover is being viewed from a distance.

In its various embodiments, the protective cover of the present invention also possesses insulative properties that serve to keep the handle warmer in colder temperatures, and cooler in hotter temperatures. The protective cover is also preferably waterproof, and may further comprise a hanging chain for proper storage when not in use so that the protective cover is not lost or misplaced. The protective cover allows a user to both cover and protect the handle of the sporting equipment quickly and easily.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the protective handle cover of the present invention in accordance with the disclosed architecture;

FIG. 2 illustrates a perspective view of one potential alternative embodiment of the protective handle cover of the present invention in accordance with the disclosed architecture;

FIG. 3 illustrates a perspective view of one potential embodiment of the protective handle cover of the present invention in accordance with the disclosed architecture and installed on a baseball bat;

FIG. 4 illustrates a partial perspective view of one potential embodiment of the protective handle cover of the present invention in accordance with the disclosed architecture, wherein the cover is supporting both an athletic shoe and a batting glove;

FIG. 5 illustrates a partial perspective view of one potential embodiment of the patch or other writable surface on an exterior surface of the protective handle cover of the present invention in accordance with the disclosed architecture;

FIG. 6 illustrates a perspective view of a plurality of potential embodiments of the protective handle cover of the present invention in accordance with the disclosed architecture;

FIG. 7 illustrates a perspective view of one potential embodiment of the protective handle cover of the present invention in accordance with the disclosed architecture, wherein the protective covers are protecting two separate baseball bats and being transported by a backpack;

FIG. 8 illustrates a partial cross-sectional view of one potential embodiment of the protective handle cover of the present invention in accordance with the disclosed architecture and showing the memory foam, ribs and ridges;

FIG. 9A illustrates a perspective view of one potential embodiment of the protective handle cover of the present invention in accordance with the disclosed architecture positioned on the handle of a hockey stick and supporting a hockey helmet; and

FIG. 9B illustrates a perspective view of one potential embodiment of the protective handle cover of the present invention in accordance with the disclosed architecture positioned on the handle of a tennis racquet.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a protective cover for a sporting equipment handle or grip area that is designed to protect the same from the elements and other damage when not in use. There is also a long felt need for a protective cover that enables a user to place shoes, sneakers, masks, helmets, etc. on the top of the handle without damaging the same, and to attach other accessories to the covered handle to ease the burden of having to simultaneously carry multiple items. Moreover, there is a long felt need in the art for a protective cover that remains securely but removably attached to the handle, and that offers a means to identify the protective cover and the equipment upon which the cover is installed. Finally, there is a long felt need in the art for a protective cover that is customizable to suit the needs and preferences of the user, is relatively inexpensive to manufacture, and that is safe and easy to use.

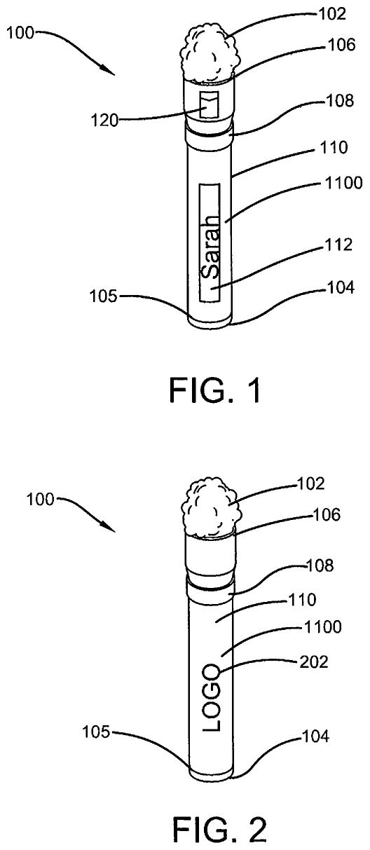

Referring initially to the drawings, FIG. 1 illustrates a perspective view of one potential embodiment of the protective handle cover 100 of the present invention in accordance with the disclosed architecture. More specifically, the protective handle cover 100 is comprised of a shaped body 110 having an exterior surface 1100 and an interior surface (not shown). The body 110 is shaped to accommodate the shape of the handle of the particular piece of sporting equipment it is designed to protect. For example, a baseball bat will have a rounded handle, and a hockey stick will have a square or rectangular handle.

The protective cover 100 is further comprised of an open end 104 and a closed top end 106. The open end 104 is sized and configured to receive the handle therein, and the closed top end 106 abuts and surrounds the end of the sporting good handle when the protective cover 100 is properly installed thereon. The closed top end 106 is preferably comprised of a memory foam 102, which will conform to the general shape of the sporting good handle (i.e., is form fitting) to help secure the protective cover 100 to the handle.

In one embodiment, the exterior surface 1100 of the protective cover 100 further comprises a hook and loop or other suitable fastener 108 to enable a user (not shown) to be able to attach accessories, such as batting gloves, wrist bands, shin guards and the like thereto. In use, the protective cover 100 is circumferentially positioned on the handle, and substantially conforms to the overall shape of the portion of the handle being covered. The exterior surface 1100 of the protective cover 100 may further comprise a patch 112 or other re-writeable and erasable surface that may be utilized by the user. More specifically, the user may write his or her name and/or contact information, or any other useful information, on patch 112 to, for example, identify the owner of the cover and/or the sporting goods in case the same are lost or misplaced.

The protective cover 100 of the present embodiment is preferably a unitary, one-piece cover having the attached or sewn memory foam 102 positioned at the top end 106 of the cover 100, and the hook and loop fastener 108 positioned elsewhere along the exterior surface 1100 of the shaped body 110. In one embodiment, the hook and loop fastener 108 is removably attached to the exterior surface 1100, and can be aligned or moved to any other position along the exterior surface 1100 of the shaped body 110 to suit user need and/or preference. In addition to the hook and loop fasteners, strips having button-snaps, or other fastening mechanisms may also be used to attach other lightweight accessories thereto. In any event, the fastener 108 is useful for supporting relatively lightweight sporting accessories, such as gloves, wristbands or the like.

In one embodiment, the protective cover 100 may further comprise a pouch or pocket 120 having a closure or other covering mechanism to store items such as a smartphone, money, a watch, etc. therein. The pocket 120 also allows the user to protect such items from the elements, such as rain, snow, moisture, etc. The protective cover 100 may be manufactured using any known manufacturing techniques or methods. Those skilled in the art will understand that one or more material pieces such as patch 112, memory foam 102, pocket 120, etc., may be stitched, glued, or seamed to the shaped body 110 in a number of different ways to achieve the protective cover 100 as described and illustrated herein.

FIG. 2 illustrates a perspective view of another potential embodiment of the protective handle cover 100 of the present invention in accordance with the disclosed architecture. In this embodiment, the exterior surface 1100 of the protective cover further comprises a logo 202, trademark, or the like. For example, the logo 202 may be present along the longitudinal axis of the protective cover 100 as shown, or along a curvature of the handle cover 100 if present. Alternatively, the protective cover 100 may have both a patch 112 and the logo 202 on the exterior surface 1100.

FIG. 3 illustrates a perspective view of one potential embodiment of the protective handle cover 100 of the present invention in accordance with the disclosed architecture and installed on a baseball bat 300. The bat 300 is comprised of a barrel 302 and a handle portion 304. More specifically, the protective cover 100 covers the handle portion 304 of the bat 300 up to the meeting point 3040 of the barrel or body portion 302, wherein the top end 3042 of the handle portion 304 is covered by the closed top end 106 of the protective cover 100, and the memory foam 102. In this manner, the protective cover 100 of the present invention conforms to the shape and size of the handle 304, and does not easily slip from the same.

In order to install the protective cover 100 onto the handle portion 304, the user (not shown) will insert the top end of the handle 3042 into the open bottom end 104 of the protective cover 100 and gently apply force to the bat 300 in the direction of the protective cover 100 (or vice versa) until the cover 100 extends to the meeting point 3040 of the barrel portion 302. Similarly, the protective cover 100 can be easily removed from the handle 304, for example, when the bat 300 is needed by the user. The length, elasticity and stretchability of the protective handle cover 100 is such that when the closed top end 106 of the cover 100 abuts the top end 3042 of the handle 304, the handle 304 is covered wholly along the length and circumference by the cover 100 of the present invention. More specifically, the material used in the manufacturing of protective cover 100 has elastic properties that permit the stretching of one or more inched in both the longitudinal and lateral directions (relative to the longitudinal axis of the bat 300) to allow the protective cover 100 to be stretched over the head of the bat handle 304. The elastic material used in protective cover 100 can be a Spandex® type of material, or may include a rubber, neoprene, latex and combinations thereof.

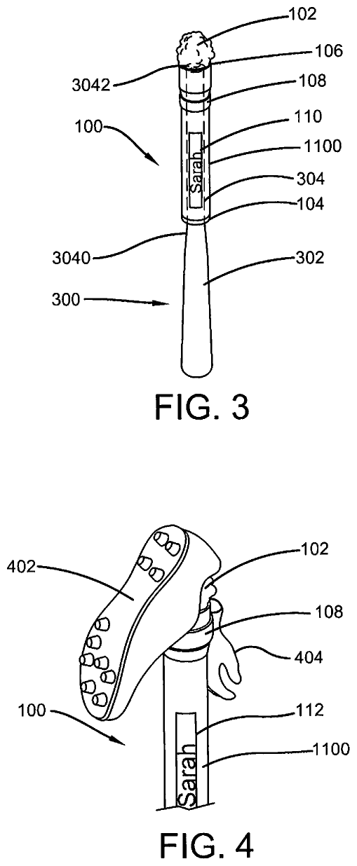

FIG. 4 illustrates a partial perspective view of one potential embodiment of the protective cover 100 of the present invention in accordance with the disclosed architecture, wherein the cover 100 is supporting both an athletic shoe 402 and a batting glove 404. More specifically, the closed top end 106 of the cover 100 of the present invention has a relatively large volume of memory foam 102 which is strong enough so that a user can place sneakers, shoes 402, helmet or the like onto the memory foam 102, wherein the memory foam 102 can be used to fit to the contour of the shoe, helmet or other item on top of the protective cover 100. Stated differently, the memory foam 102 forms a bulbous region on top of the protective cover 100 to fit into the item being held on top of the protective cover 100. Further, the size or amount of memory foam 102 utilized may correspond to the shape and size of the item to be supported or carried. For example, a hockey helmet would require more memory foam 102 than a shoe 402. The size and volume of the memory foam 102 is able to support the shoe 402, and the shoe 402 will not fall off when the bat 300 is carried with the protective cover 100 and the shoe 402 thereon.

Additionally, the hook and loop fastener 108 present around the exterior surface 1100 of the protective cover 100 can be used to affix or attach, for example, a lightweight batting glove 404. In this manner, the protective cover 100 of the present invention not only protects the bat handle 304 from weather and/or other physical damage, but it also allows the user to carry multiple items, such as sneakers 402, gloves 404 and the like without having to separately transport the same. Similarly, the memory foam 102 serves multiple functions, not only conforming to the shape of the handle top, but also providing a support for supplemental equipment carried by the handle and protective cover combination.

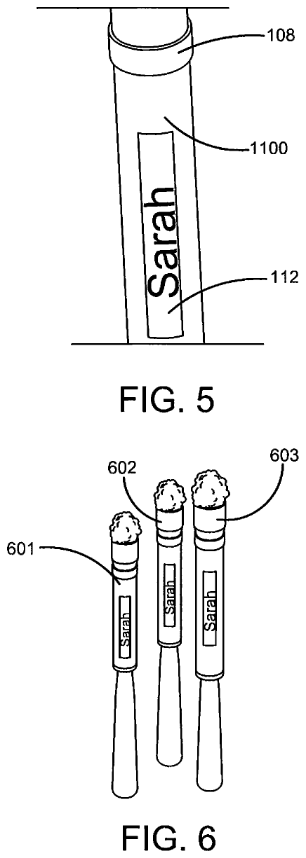

FIG. 5 illustrates a partial perspective view of one potential embodiment of the patch 112 or other writable surface on an exterior surface 1100 of the protective handle cover 100 of the present invention in accordance with the disclosed architecture. More specifically, the patch 112 may be sewn or attached via an adhesive, such as a hot melt acrylic, which forms a permanent bond on the exterior surface 1100 of the protective cover 100. Alternatively, the patch 112 may be removably attached to the exterior surface 1100 of the protective cover 100 via a fastener system including, without limitation, hook and loop fasteners, buttons, clasps, snaps, and the like. The patch 112 may be used to write a name, contact number, email address or any other similar information to uniquely identify the cover 100 or the piece of sporting equipment whose handle is covered by the cover 100. The patch 112 may also comprise a team name, company name, logo 202 or the like.

FIG. 6 illustrates a perspective view of a plurality of potential embodiments of the protective handle cover 100 of the present invention in accordance with the disclosed architecture. More specifically, the protective covers 601, 602, 603 may be manufactured in a variety of different colors, configurations and designs to suit the needs and/or preferences of the user. For example, the protective covers 601, 602, 603 may be available in different sizes to fit different handles of different types of sporting equipment. Nonetheless, the flexible nature of the protective cover 100 and the memory foam 102 has the ability to adapt its shape upon insertion of a handle, thereby enabling use with sporting equipment of various sizes.

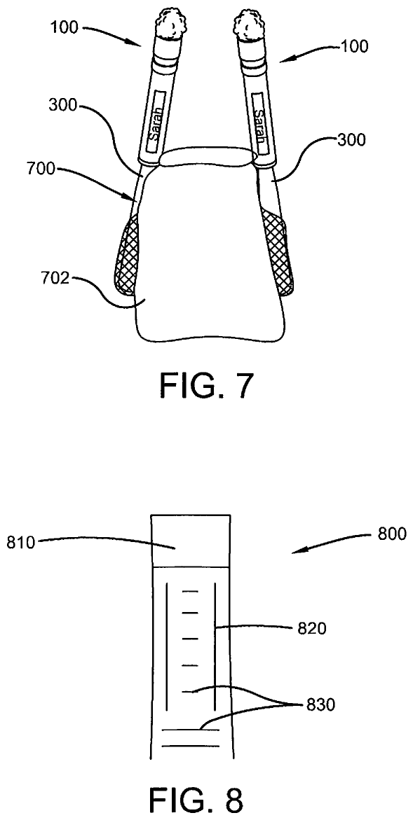

FIG. 7 illustrates a perspective view of one potential embodiment of the protective handle covers 100 of the present invention in accordance with the disclosed architecture, wherein the protective covers 100 are protecting two separate baseball bats 300 that are being transported by a backpack 700. More specifically, baseball/softball bats 300 are often carried around in a specialized backpack 700 by users, and the structure and design of such backpacks 700 are such that the handle portion 304 of the bat 300 is naturally exposed to the elements and potential physical damage. As previously stated, prolonged exposure to sunlight, heat, moisture, rain, mud, dust and general inclement weather may result in damage to the bat handle 304, which is undesirable and may result in the user having to replace the bat. Accordingly, the protective cover 100 of the present invention plays an important role in protecting the bat handle 304 and the bat 300 itself.

In yet another embodiment of the present invention, a method for protecting a handle, such as bat handle 304, from the weather and/or physical damage when not in use comprises the step of initially providing a handle protective cover 100 comprised of an elastic and/or stretchable material, as described herein in its various embodiments. Once so provided, the top end of the handle 3042 is inserted into the open bottom end 104 of the protective cover 100 and gentle pressure is applied to the bat 300 in the direction of the protective cover 100 (or vice versa) until the cover 100 extends to the meeting point 3040 of the barrel portion 302, and the closed top end 106 of the protective cover 100 abuts the top end 3042 of the handle 304. Next, a user may use the patch 112 to identify the owner of the bat 300 and/or protective cover 100 by providing the user's name and appropriate contact information thereon. Next, the user may also utilize the hook and loop fastener 108 provided on an exterior surface 1100 of the protective cover to attach, for example, a batting glove 404 or other accessory to the exterior surface of the protective cover 100. Next, the user may place, for example, his or her shoes 402 on the bulbous memory foam 102 positioned atop the cover to avoid having to separately transport the same. It is also contemplated that yet another cover (i.e., as an accessory to the protective cover 100) can then be placed over top of the shoes 402 positioned on the protective cover 100 to shield the same from the elements and/or other physical damage.

In a further embodiment, the material used for manufacturing the protective cover 100 may be comprised of at least one of a neoprene, natural rubber, and/or polypropylene to offer greater weather protection and physical resistance, and to protect the handle 304 from cracking, expansion, and other undesirable effects. This allows the protective bat cover 100 to increase the range of temperatures in which the sporting equipment may be used without being damaged. Further, the exterior surface 1100 of the protective cover 100 is preferably smooth and relatively uniform, but may optionally contain ridges which may help aid in better gripping of the protective cover 100. As previously stated, the cover 100 may further comprise logos, indicia, trademarks, geometric patterns, customizable colors and fonts, embroidery and prints and/or images or combinations thereof 202 on its surface. Also, the bottom end of the cover 100 is tightly secured to the handle to discourage the entry of water, dirt and debris into the interior of the cover 100. To that end, the exterior of the bottom edge of the protective cover 100 may further comprise an elastic band 105, as best shown in FIG. 1, for keeping the cover close to the surface of the handle that it is being used to protect.

FIG. 8 illustrates a partial cross-sectional view of one potential embodiment of the protective handle cover 800 of the present invention in accordance with the disclosed architecture. More specifically, protective handle cover 800 comprises memory foam 810, one or more ribs 820 and one or more ridges 830. The memory foam 810 is positioned on an exterior surface of the top of the protective cover 800, similar in position and function to memory foam 102 discussed supra. The interior surface of the protective handle cover 800 comprises the ribs 820 and ridges 830 for gripping of the handle stored therein, wherein the ribs 820 preferably run parallel to the length of the protective cover 800, and the ridges 830 preferably run substantially perpendicular to the length of the protective cover 800, or vice versa. Nonetheless, the protective cover 800 is not so limited, and other orientations of ribs 820 and ridges 830 are also contemplated. The ribs 820 and ridges 830 are preferably comprised of a rubberized material so as to provide additional anti-slip qualities or characteristics to the interior surface of the protective cover 100.

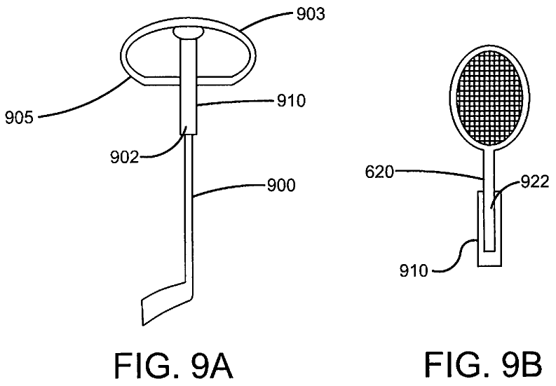

FIG. 9A illustrates a perspective view of one potential embodiment of the protective handle cover 910 of the present invention in accordance with the disclosed architecture positioned on the handle 902 of a hockey stick 900 and supporting a hockey helmet 905. More specifically, the protective cover 910 is positioned over the handle portion 902 of the hockey stick 900, and further comprises a portion of memory foam 903 positioned on its top portion in a fashion similar to that described previously. In turn, the memory foam 903 is used to support the user's hockey helmet 905, thereby eliminating the need for the user to have to separately transport the same.

Similarly, FIG. 9B depicts the protective cover 910 of the present invention positioned over a handle portion 922 of a tennis racket 920 to protect the same from the weather and/or other potential physical damage when not in use. Clearly, the protective covers of the present invention, in all of their various embodiments, may be used with any sort of sporting equipment including, without limitation, baseball, softball, cricket, lacrosse, hockey, tennis, Jai alai and the like, and the shape of the protective covers may be tubular, square, rectangular, curved, or any shape which may be needed to cover the handle and grip area of a piece of sporting good equipment.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “protective bat handle cover”, “protective cover”, “cover”, “handle cover”, and “bat handle cover” are interchangeable and refer to the protective cover 100 of the present invention.

Notwithstanding the forgoing, the protective cover 100 of the present invention and its various components can be of any suitable shape, size and configuration as is known in the art without affecting the overall concept of the invention, provided that the same accomplishes the above stated objectives. One of ordinary skill in the art will appreciate that the shape, size, configuration and material of the protective cover 100 as shown in the FIGS. are for illustrative purposes only, and that many other shapes, sizes, configurations and materials of the protective cover 100 and its various components are well within the scope of the present disclosure. Although the dimensions of the protective cover 100 and its components are important design parameters for user convenience, the protective cover 100 and its various components may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective cover for a sporting good handle, the protective cover comprising:
a shaped body having a closed end, an open end opposite the closed end, an interior surface, an exterior surface, and an internal cavity;
a patch disposed on the exterior surface, wherein the patch is capable of receiving a variable indicia and is comprised of a rewritable and erasable surface; and
a memory foam material positioned on the closed end of the shaped body.

2. The protective cover for a sporting good handle as recited in claim 1, wherein the memory foam is provided in the internal cavity at the closed end for forming a shape to the sporting good handle.

3. The protective cover for a sporting good handle as recited in claim 1, wherein the memory foam is provided on the exterior surface of the shaped body at the closed end.

4. The protective cover for a sporting good handle as recited in claim 1, wherein the memory foam is provided both inside the internal cavity and on the exterior surface of the shaped body at the closed end.

5. The protective cover for a sporting good handle as recited in claim 1, wherein the internal surface is comprised of at least one rib and at least one ridge.

6. The protective cover for a sporting good handle as recited in claim 5, wherein the at least one rib and at least one ridge are comprised of a rubberized material.

7. The protective cover for a sporting good handle as recited in claim 1, wherein the exterior surface is provided with a fastening system for securing an accessory to the shaped body.

8. The protective cover for a sporting good handle as recited in claim 1 further comprising an elastic band positioned on the exterior surface of the open end of the shaped body.

9. The protective cover for a sporting good handle as recited in claim 1, wherein the exterior surface is comprised of at least one of a logo, an indicia, a trademark, a pattern, an embroidery, a print, an image or a combination thereof.

10. The protective cover for a sporting good handle as recited in claim 5, wherein the at least one rib has a first orientation and the at least one ridge has a second orientation, and further wherein the first orientation differs from the second orientation.

11. The protective cover for a sporting good handle as recited in claim 1, wherein the shaped body is substantially tubular.

12. A cover and accessory holder for a sporting good comprising;
a cover comprising an open end, a closed end, an interior cavity, and an exterior surface; and
a fastening strap positioned on the exterior surface of the cover for fastening an accessory to the exterior surface of the cover, wherein the closed end is comprised of a memory foam material disposed on the exterior surface, and further wherein the memory foam material conforms to a shape of the sporting good coming into contact therewith.

13. The cover and accessory holder for a sporting good as recited in claim 12, wherein the exterior surface comprises a rewritable and erasable patch for displaying a set of information.

14. The cover and accessory holder for a sporting good as recited in claim 12, wherein the cover has a shape selected from a tube, a cylinder, a square, or a rectangle.

15. The cover and accessory holder for a sporting good as recited in claim 12, wherein the memory foam material is also present in the internal cavity.

16. The cover and accessory holder for a sporting good as recited in claim 12, wherein the shaped body is substantially cylindrical.

17. A combination sporting good handle and protective cover comprising;
a sporting good handle, wherein the sporting good handle forms a portion of a baseball bat, a softball bat, a cricket bat, a lacrosse stick, a hockey stick, a tennis racquet, a Jai alai racquet, or a racquet;
a protective cover comprised of a top end, a bottom end, an interior cavity and an exterior surface, wherein the interior cavity is sized and configured to accommodate a shape of the sporting good handle; and
a memory foam that adapts to the shape of the sporting good handle.

18. The combination sporting good handle and protective cover as recited in claim 17, wherein the exterior surface is comprised of a patch having a rewritable and erasable surface.

19. The combination sporting good handle and protective cover as recited in claim 17, wherein the protective cover further comprises an interior surface comprised of at least one of a plurality of ribs or a plurality of ridges.

20. The combination sporting good handle and protective cover as recited in claim 17, wherein the exterior surface of the protective cover further comprises a fastening system for attaching an accessory.
